(19) United States
(12) Patent Application Publication
(10) Pub. No.: US 2004/0132956 A1
(43) Pub. Date: Jul. 8, 2004

(54) Thermosetting resin composition for vacuum, method for manufacturing the same, and vacuum device using the same

(76) Inventors: Toshikazu Hamao, Fukuoka (JP); Nobuhiko Ota, Fukuoka (JP); Yoshifusa Tsubone, Fukuoka (JP)

Correspondence Address: SUGHRUE MION, PLLC, 2100 PENNSYLVANIA AVENUE, N.W., SUITE 800, WASHINGTON, DC, 20037, US

(21) Appl. No.: 10/466,527

(22) PCT Filed: Jan. 17, 2002
(86) PCT No.: PCT/JP02/00295

(30) Foreign Application Priority Data
Jan. 18, 2001 (JP) 2001-10409

(51) Int. Cl. C08G 59/40

(52) U.S. Cl. 528/112

(57) ABSTRACT

To obtain a thermosetting resin composition which obviates a necessity for subjecting the composition to canning even in a vacuum and which involves emission of a small amount of an organic-based gas, and a device for use in a vacuum using the thermosetting resin.

A thermosetting resin composition of the invention adopts epoxy resin as a main compound, and at least either a curing agent or a catalyst is blended with the main compound. A content of a low molecular organic substance having a molecular weight of 400 or less in the compound is set to 10,000 ppm or less, preferably 1,000 ppm or less. In order to eliminate the low molecular organic substance, there is employed a method for subjecting the compound to heat treatment or decompression treatment, a method for using a specific curing agent of polyaddition type, a method for using a specific catalyst, or a combination thereof. The curing agent of polyaddition type is first amine, second amine, acid anhydride, phenolic novolak, or polymercaptan. The catalyst is imidazole or of cationic polymerization type.

### TECHNICAL FIELD

The invention relates to thermosetting resin, such as epoxy resin, used in a vacuum, as well as to a device for use in a vacuum (hereinafter called a “vacuum-use device”) using the thermosetting resin.

### BACKGROUND ART

In relation to a vacuum-use device, thermosetting resin, such as an epoxy resin composition, is used in a substrate of an electronic circuit, a molding member of an electromagnetic coil, or an electrical insulating member. A gas emitted from the thermosetting resin in a vacuum has water as the main ingredient in a low vacuum range. However, an organic-based gas is also emitted from the thermosetting resin in a high vacuum range, thereby posing a problem of contamination of a vacuum device and a vacuum atmosphere.

Drawbacks induced by contamination due to the organic-based gas include, for example, admixture of an organic substance as impurities inducing a change in the physical properties of a film produced by means of sputtering or chemical vapor phase deposition; and a hydrocarbon film formed on a wafer through ion implantation during the course of manufacture of a semiconductor being susceptible to a failure in a subsequent etching process or a like process.

An example countermeasure against these drawbacks is metal-canning components using a thermosetting resin composition in a vacuum-use device to be used in a vacuum range. FIG. 13 is a lateral cross-sectional view showing an electromagnetic coil subjected to conventional canning. Reference numeral 1 designates a stator core; 2 designates a coil; 3 designates a mold formed from a thermosetting resin composition; 4 designates a stator housing; and 5 designates a metal can. The metal can 5 isolates a vacuum atmosphere from the mold 3 formed from a thermosetting resin composition, thereby preventing pollution, which would otherwise be caused by an organic-based gas.

However, when the vacuum-use device has been canned with metal, a limitation is imposed on the degree of geometrical freedom of the device, thereby hindering miniaturization and a reduction in weight of the device and in turn adding to costs. When metal canning is applied to an electromagnetic coil, the can adversely affects the magnetic characteristic of the coil.

### DISCLOSURE OF THE INVENTION

Accordingly, the invention aims at providing a thermosetting resin composition and a vacuum-use device, which obviate a necessity for canning in a vacuum and involve emission of a small quantity of organic-based gas.

To solve the drawbacks, the present invention provides a thermosetting resin composition for use in a vacuum, comprising a main compound and at least either a curing agent or a catalyst, which are blended together, wherein a low-molecular organic substance having a molecular weight of 400 or less in the composition has a content of 10,000 ppm or less, preferably, 1,000 ppm or less.

To this end, epoxy resin is used as the main compound, and a low molecular organic substance is eliminated by adoption of heat treatment or decompression treatment, use of a specific curing agent of polyaddition type, use of a specific catalyst, or a combination of these measures.

When heat treatment or decompression treatment is performed, a state of the composition may be set to either a component unit or mixture before curing, or to a cured substance after curing. The temperature employed for heat treatment is set to 250° C. or less; a pressure P employed in the decompression treatment is set to a vapor pressure of the low molecular organic substance at the temperature T, preferably, a pressure defined by the following equation:

log₁₀ P<8.125−2000/(T−73.15), wherein

P: a pressure employed in decompression treatment [Pa], T: a temperature employed in heat treatment [K].

Moreover, the temperature T may be higher than or equal to a glass-transition temperature of the cured substance.

When a specific polyaddition-type curing agent is used, the curing agent is primary amine or secondary amine, and a stoichiometric ratio of active hydrogen of the curing agent to an epoxy radical of the epoxy resin is 0.5 to 1.4, preferably 0.7 to 1.2.

The curing agent is acid anhydride, and a stoichiometric ratio of an acid anhydride radical to the epoxy radical of the epoxy resin is 0.5 to 1.4, preferably 0.7 to 1.2.

The curing agent is phenolic novolak, and a stoichiometric ratio of a phenolic hydroxyl-type to the epoxy radical of the epoxy resin is 0.5 to 1.2, preferably 0.5 to 1.0.

The curing agent is phenolic novolak; a stoichiometric ratio of a phenolic hydroxyl-type to the epoxy radical of the epoxy resin is 0.5 to 1.2, preferably 0.6 to 1.1; and the catalyst is a basic catalyst.

Moreover, the curing agent is polymercaptan, and a stoichiometric ratio of active hydrogen of the curing agent to the epoxy radical of the epoxy resin is 0.5 to 1.0, preferably 0.6 to 0.9.

When a specific catalyst is used, the catalyst is imidazole or of cationic polymerization type.

As mentioned above, the invention yields the following effects.

(1) Epoxy resin, and the curing agent or catalyst are subjected to heat treatment or decompression treatment before or after mixing at a temperature of 250° C. or less. The pressure P is set to a vapor pressure of the low molecular organic substance at the temperature T or less. Hence, a non-reactive organic substance included in the epoxy resin, the curing agent or catalyst, or a mixture thereof can be eliminated.

(2) A cured substance is subjected to heat treatment or decompression treatment. The temperature T of the treatment is 250° C. or less and higher than or equal to a glass-transition temperature of the cured substance. The pressure P is set to a vapor pressure of the low molecular organic substance or less at the temperature T. Accordingly, a low molecular organic substance included in the cured substance can be removed.

(3) The cured substance is subjected to heat treatment, and the temperature T of the heat treatment is set so as to become higher than or equal to a glass-transition temperature of the cured substance. Hence, a low molecular organic substance included in the cured substance can be removed.

The curing agent is of polyaddition type. When primary amine or secondary amine is employed as the curing agent, a stoichiometric ratio of active hydrogen of the curing agent to an epoxy radical of the epoxy resin is 0.5 to 1.4. When acid anhydride is employed as the curing agent, a stoichiometric ratio of an acid anhydride radical to the epoxy radical of the epoxy resin is 0.5 to 1.4. When phenolic novolak is employed as the curing agent, the stoichiometric ratio of a phenolic hydroxyl-type to the epoxy radical of the epoxy resin is 0.5 to 1.2. When phenolic novolak is employed as the curing agent along with a basic catalyst, a stoichiometric ratio of a phenolic hydroxyl-type to the epoxy radical of the epoxy resin is 0.5 to 1.2. When polymercaptan is employed as the curing agent, a stoichiometric ratio of active hydrogen of the curing agent to the epoxy radical of the epoxy resin is 0.5 to 1.0. As a result, the epoxy resin and the curing agent are reacted to form at least an oligomer, whereby no unreacted substance remains.

(5) The catalyst is imidazole or of cationic polymerization type. Since the epoxy resin is self-crosslinked, remaining of unreacted epoxy resin or curing agent can be prevented without regard to a compounding ratio of epoxy resin to a curing agent

As mentioned above, a low molecular organic substance which is contained in the thermosetting resin composition and has a molecular weight of 400 or less is set to a content of 10,000 ppm or less with reference to the overall weight of the thermosetting resin composition. As a result, the amount of organic-based gas emitted from the thermosetting resin composition in a vacuum becomes smaller. Consequently, use of the thermosetting resin composition yields an advantage of the ability to reduce the quantity of organic-based gas emitted from the vacuum-use discharge.

### BRIEF DESCRIPTION OF THE DRAWINGS

FIG. 1 is a graph showing the effect of a first embodiment of the invention;

FIG. 2 is a graph showing the effect of a second embodiment of the invention;

FIG. 3 is a graph showing an effect exerted on the amount of emitted gas by heat/decompression treatment requirements in a third embodiment of the invention;

FIG. 4 is a graph showing an effect exerted on the amount of emitted gas by a relationship between the temperature of heat treatment and the glass-transition temperature of a cured substance in the third embodiment of the invention;

FIG. 5 is a graph showing an effect exerted on the amount of emitted gas by a compounding ratio of an amine-type curing agent in a fourth embodiment of the invention;

FIG. 6 is a graph showing an effect exerted on the amount of emitted gas by a compounding ratio of an acid-anhydride-type curing agent to a catalyst when the catalyst is added to the curing agent in the fourth embodiment of the invention;

FIG. 7 is a graph showing an effect exerted on the amount of emitted gas by a compounding ratio of the phenolic-novolak-type curing agent in the fourth embodiment of the invention;

FIG. 8 is a graph showing an effect exerted on the amount of emitted gas by a compounding ratio of the phenolic-novolak-type curing agent to the catalyst when the catalyst is added to the curing agent in the fourth embodiment of the invention;

FIG. 9 is a graph showing an effect exerted on the amount of emitted gas by a compounding ratio of the polymercaptan-type curing agent in the fourth embodiment of the invention;

FIG. 10 is a graph showing an effect of a fifth embodiment of the invention;

FIG. 11 is a graph showing the summary of effects achieved in the first through fifth embodiments of the invention;

FIG. 12 is a lateral cross-sectional view of a vacuum electromagnetic coil showing a sixth embodiment of the invention; and

FIG. 13 is a lateral cross-sectional view showing the structure of a conventional vacuum electromagnetic coil.

### BEST MODES FOR IMPLEMENTING THE INVENTION

Embodiments of the invention will now be described.

A result of ardent study about a source for emission of an organic-based gas has led to finding of a decrease in the quantity of organic-based gas emitted in a vacuum and also a decrease in the content of a low molecular organic substance included in a cured substance of a thermosetting resin composition. The low molecular organic substance has a molecular weight of 400 or less. The low molecular organic substance is roughly categorized into a non-reactive component, such as a solvent used for diluting impurities in a raw material, a curing agent, and a catalyst, all being used as a raw material, or diluting a raw material; an unreacted material which has not been taken into a polymeric chain through curing reaction; and by-products stemming from curing reaction.

Impurities included in the non-reactive component are considered to be by-produced or to remain when a raw material is synthesized or purified. In the case of, e.g., an impregnated molding material, when high viscosity epoxy resin having a larger molecular weight is used for preventing cracking, a non-reactive organic solvent added for dissolution is considered to remain as the solvent in the non-reactive component. In the case of, e.g., a prepreg or a coating material, when a solid material is used, a non-reactive organic solvent added for solution is considered to remain as the solvent in the non-reactive component.

The unreacted material is considered to be a residual raw material which remains because of an incomplete curing reaction due to an insufficient curing temperature and an insufficient curing time, or an excess produced as a result of either epoxy resin or a curing agent being excessively mixed at the time of blending of an polyaddition-type curing agent.

A by-product of curing reaction is considered to stem from dissociation of a part of catalyst molecules when the catalyst has been activated.

Consequently, emission of an organic-based gas is considered to be suppressed by reducing the content of the low molecular organic substance existing in the cured substance.

### FIRST EMBODIMENT

This embodiment is an example for inhibiting emission of an organic-based gas through treatment for removing a non-reactive content from a raw material before mixing.

A non-reactive component, such as a solvent used for diluting impurities in a raw material (a main compound, a curing agent, and a catalyst) or a raw material, is usually higher in vapor pressure than epoxy resin or a curing agent. Hence, removal of the non-reactive component is considered possible by subjecting the raw material to heat treatment or decompression treatment.

The low molecular organic substance becomes more easily removed as the temperature of heat treatment becomes higher. Further, the low molecular organic substance becomes more easily removed as the pressure of decompression treatment becomes lower. The effect becomes more enhanced by decompressing pressure to or below the vapor pressure of the low molecular organic substance.

When water adsorbed or absorbed by the vacuum-use device is removed by heat/decompression treatment; that is, baking, emission of an organic-based gas from the cured substance of thermosetting resin used in the vacuum-use device must be inhibited. In this application, previous removal of a low molecular organic substance whose vapor pressure is higher than that of water is desired. Pressure used for decompressing a raw material must be equal to or lower than the vapor pressure of water.

When impurities mixed into the raw material cannot be specified, the pressure defined by Equation (1) is used; namely,

log₁₀ P<8.125−2000/(T−73.15): where (1)

P: a pressure employed in decompression treatment [Pa], T: a temperature employed in heat treatment [K]. This equation takes the form of an Antoine equation representing a relationship between the temperature and vapor pressure of a substance. The equation is determined from relationships between temperatures and vapor pressures of various low molecular organic substances.

The first embodiment of the invention will now be described. The embodiment is an example in which a non-reactive component is removed before preparation of a raw material, and emission of an organic-based gas is inhibited. A sample, a method for manufacturing the sample, and a method for evaluating the sample are as follows.

(1) Sample

Samples were formed by combination of the following materials so as to assume a compounding ratio shown in Table 1.

Epoxy resin: bisphenol A type (BPA type), epoxy 190. equiv.

Diluent: Toluene

Curing agent: 4,4′diaminodiphenylmethane (DDM), methyltetrahydro phthalic anhydride (MeTHPA)

Catalyst: 2-ethyl-4-methyl-imidazole (2E4MZ).

(2) Method for Manufacturing the Sample

In relation to manufacture of the sample, after a low molecular organic substance has been removed from the epoxy resin, the epoxy resin was blended with a curing agent and a catalyst, to thereby cure the epoxy resin. Three methods for curing resin were adopted; that is, a method for adding solely a curing agent to epoxy resin (Sample Nos. 1 through 6); a method for adding a curing agent to epoxy resin along with a catalyst (Sample Nos. 7 to 12); and a method for adding solely a catalyst to epoxy resin (Sample Nos. 13 to 18). Curing requirements for all the samples included a temperature of 150° C. and five hours. A low molecular organic substance was not removed from samples for comparison purpose (Nos. 1 through 3, 7 through 9, and 13 through 15). For example, Sample Nos. 3, 9, and 15 were formed by adding 10 parts by weight of toluene, as a non-reactive component, to 100 parts by weight of epoxy resin and curing the samples without removal of the toluene.

(3) Method for Removing Low Molecular Organic Substance

Removal of a low molecular organic substance (hereinafter sometimes abbreviated as simply “removal treatment”) was given the following three requirements. Five minutes were set for the respective samples as processing times.

20° C.×3000 Pa (Sample Nos. 4, 10, 16)

100° C.×100 Pa (Sample Nos. 5, 11, 17)

250° C.×100 Pa (Sample Nos. 6, 12, 18).

A pressure of 3,000 Pa (101300 Pa: atmospheric pressure) at 20° C. is higher than the vapor pressure of toluene at 20° C. A pressure of 100 Pa at 100° C. is lower than the vapor pressure of toluene at 100° C. but higher than the pressure at 100° C. determined by Equation (1). The pressure 100 Pa achieved at 250° C. is lower than the pressure achieved at 250° C. determined by Equation (1). When the temperature achieved during decompression treatment is too high, there arises apprehension that thermal decomposition of a raw material causes a decomposition product to become an outgassing species. In the embodiment, the highest temperature was set to 250° C.

(4) Evaluation Method

A cured substance was evaluated by means of a content of a low molecular organic substance and the amount of an organic-based gas emitted in a vacuum. The content of the low molecular organic substance was determined by extracting acetone from a pulverized cured substance by means of the Soxhlet method and measuring the amount of extracted substance having a molecular weight of 400 or less. The quantity of the organic-based gas emitted in a vacuum was determined by a quadrupole mass spectrometer (QMS).

Evaluation results were recorded by reference to the following marks. A content of low molecular organic substance assuming a value of 100 ppm or less is denoted by \mathring{∘} ; a content of low molecular organic substance assuming a value of 101 to 1,000 ppm is denoted by ◯; a content of low molecular organic substance assuming a value of 1,001 to 10,000 ppm is denoted by Δ; and a content of low molecular organic substance assuming a value of 10,001 ppm or more is denoted by ×. A quantity of organic-based gas emitted assuming a value of 1×10⁻¹² A or less is denoted by ◯; a quantity of organic-based gas emitted assuming a value of 1.1×10⁻¹² to 1×10⁻¹¹ A is denoted by Δ; and a quantity of organic-based gas emitted assuming a value of 1.1×10⁻¹¹ A or higher is denoted by ×.

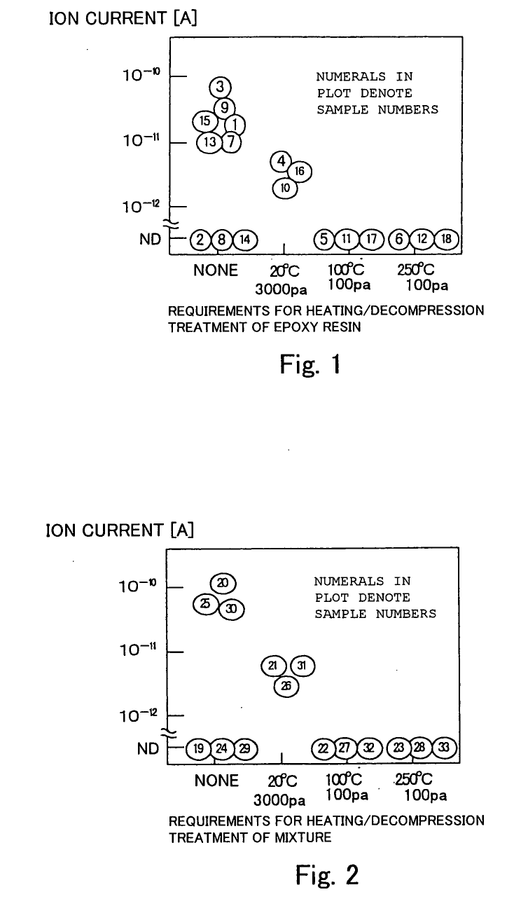

Next, Table 1 and FIG. 1 show measurement results pertaining to the content of low molecular organic substance and to the amount of organic-based gas emitted.

TABLE 1

| | MATERIAL COMPOUNDING RATIO | | | | | | | | EVALUATION | |
|---|---|---|---|---|---|---|---|---|---|---|
| | EPOXY | | | | | | | | | AMOUNT OF |
| | (190 | | | CURING | | | REQUIREMENTS FOR | | PERCENTAGE OF | ORGANIC- |
| | EQUIV. ) | | | AGENT | | | REMOVAL OPERATION | | LOW-MOLECULAR | BASED |
| SAMPLE | BPA | BPA | DILUENT | | MeTHP | CATALYST | TEMP | PRESSURE | ORGANIC | GAS |
| NO. | TYPE-1 | TYPE-2 | TOLUENE | DDM | A | 2E4MZ | (° C.) | (Pa) | SUBSTANCE | EMISSION |
| 1 | 100 | — | — | 28 | — | — | — | — | X | X |
| 2 | — | 100 | — | 28 | — | — | — | — | ◯ | ◯ |
| 3 | — | 100 | 10 | 28 | — | — | — | — | X | X |
| 4 | — | 100 | 10 | 28 | — | — | 20 | 3000 | Δ | Δ |
| 5 | — | 100 | 10 | 28 | — | — | 100 | 100 | ◯ | ◯ |
| 6 | — | 100 | 10 | 28 | — | — | 250 | 100 | ⊚ | ◯ |
| 7 | 100 | — | — | — | 80 | 2 | — | — | X | X |
| 8 | — | 100 | — | — | 80 | 2 | — | — | ◯ | ◯ |
| 9 | — | 100 | 10 | — | 80 | 2 | — | — | X | X |
| 10 | — | 100 | 10 | — | 80 | 2 | 20 | 3000 | Δ | Δ |
| 11 | — | 100 | 10 | — | 80 | 2 | 100 | 100 | ◯ | ◯ |
| 12 | — | 100 | 10 | — | 80 | 2 | 250 | 100 | ⊚ | ◯ |
| 13 | 100 | — | — | — | — | 4 | — | — | X | X |
| 14 | — | 100 | — | — | — | 4 | — | — | ◯ | ◯ |
| 15 | — | 100 | 10 | — | — | 4 | — | — | X | X |
| 16 | — | 100 | 10 | — | — | 4 | 20 | 3000 | Δ | Δ |
| 17 | — | 100 | 10 | — | — | 4 | 100 | 100 | ◯ | ◯ |
| 18 | — | 100 | 10 | — | — | 4 | 250 | 100 | ⊚ | ◯ |

It came to light that Sample Nos. 1, 7, and 13 contain a low molecular organic substance in an amount of 10,000 ppm or more, assume a large ion current of 10-11 A or higher representing the amount of an emitted organic-based gas emitted, and emit a large quantity of organic-based gas. Sample Nos. 2, 8, and 14 contain a low molecular organic substance in an amount of 1,000 ppm or less, and no organic-based gas was detected.

Of the samples doped with toluene, Sample Nos. 3, 9, and 15, which have been cured without being subjected to removal treatment, contain a low molecular organic substance in an amount of 10,000 ppm or higher, assume an organic-based-gas ion current of 10⁻¹¹ A or higher, and emit a large quantity of organic-based gas. In contrast, Sample Nos. 4, 10, and 16, which have been treated under conditions of “20° C. and 3,000 Pa,” have a content of low molecular organic substance and assume an organic-based gas ion current which are an order of magnitude smaller than those of the samples 3, 9, 15. Sample Nos. 5, 11, and 17, which have been processed at 100° C. and 100 Pa, and Sample Nos. 6, 12, and 18, which have been processed at 250° C. and 100 Pa, contain a low molecular organic substance in an amount of 1,000 ppm or less. No organic-based gases were not detected from these samples.

Consequently, in order to eliminate the added organic solvent, it can be understood that the raw material must be subjected to heat/decompression treatment at a heating temperature and the vapor pressure of an organic solvent or less, thereby inhibiting emission of an organic-based gas. Further, in order to eliminate a non-reactive component whose compositions are not obvious, such as impurities mixed into a raw material, it can be understood that the raw material must be subjected to heat/decompression treatment at a heating temperature and under pressure expressed by Equation (1), thereby inhibiting emission of an organic-based gas. Any of the curing methods are understood to yield effects of heat/decompression treatment.

Consequently, the amount of organic-based gas emitted is reduced by heat treatment or decompression treatment of epoxy resin material, thereby enabling production of a thermosetting resin composition which involves an organic-based-gas ion current of 10⁻¹¹ A or less, emits a small quantity of organic-based gas, and can be applied to use under high vacuum.

Needless to say, the treatment operations are effective for epoxy resin containing outgassing species, such as Sample Nos. 1, 7, and 13.

### SECOND EMBODIMENT

The present embodiment is an example for eliminating a non-reactive component, as in the case of the first embodiment. In the embodiment, after a raw material has been mixed, the non-reactive component is removed through treat/decompression treatment, thereby inhibiting emission of an organic-based gas.

Examples of the second embodiment of the invention will now be described. Samples were manufactured in the following manner. Here, the method for evaluating cured substances and display of evaluation results are the same as those in the first embodiment.

(1) Sample

Samples were formed by combination of the following materials so as to assume compounding ratios shown in Table 2.

Epoxy resin: bisphenol A type (BPA type), epoxy 480. equiv.

Diluent: Toluene

Curing agent: metaphenylenediamine (MPD), methylhexahydrophthalicanhydride (MeHPA)

Solvent: Methylethylketone

Catalyst: 2-methyl-imidazole (2MZ).

(2) Method for Manufacturing Samples

In relation to manufacture of samples, after epoxy resin had been blended with a curing agent and a catalyst, a low molecular organic substance was removed, and the resultant resin was cured. Curing of resin was conducted three in manners as in the case of the first embodiment; that is, a method for adding solely a curing agent to epoxy resin; a method for adding a curing agent to epoxy resin along with a catalyst; and a method for adding solely a catalyst to epoxy resin. All the samples were cured at 150° C. for five hours.

For comparison purpose, samples (Nos. 19 and 20, 24 to 25, and 29and 30) were not subjected to removal of a low-molecular organic substance. For example, Sample Nos. 20, 25, and 30 were formed by adding 25 parts by weight of toluene, as a non-reactive component, to 100 parts by weight of epoxy resin; adding 25 parts by weight of methylethylketone to a solid curing agent and a catalyst, such as MPD and 2MZ; and curing the samples without removal of the toluene or methylethylketone.

(3) Method for Removing Low Molecular Organic Substance

Removal of a low molecular organic substance is performed under the following three sets of requirements, as in the case of the first embodiment.

20° C.×3000 Pa (Sample Nos. 21, 26, 31)

100° C.×100 Pa (Sample Nos. 22, 27, 32)

250° C.×100 Pa (Sample Nos. 23, 28, 33).

Next, the content of low molecular organic substance and the quantity of organic-based gas emitted were measured. Results of measurement are provided in Table 2 and FIG. 2.

TABLE 2

| | | | | | | | | | EVALUATION | |
|---|---|---|---|---|---|---|---|---|---|---|
| | MATERIAL COMPOUNDING RATIO | | | | | | REQUIREMENTS | | PERCENTAGE | |
| | EPOXY | | | | | | FOR REMOVAL | | OF LOW- | AMOUNT OF |
| | BPA TYPE | | CURING | | | | OPERATION | | MOLECULAR | ORGANIC- |
| SAMPLE | (480 | DILUENT | AGENT | | CATALYST | SOLVENT | TEMP | PRESSURE | ORGANIC | BASED GAS |
| NO. | EQUIV.) | TOLUENE | MPD | MeHHPA | 2MZ | MEK | (° C.) | (Pa) | SUBSTANCE | EMISSION |
| 19 | 100 | — | 5.5 | — | — | — | — | — | ◯ | ◯ |
| 20 | 100 | 25 | 5.5 | — | — | 5.5 | — | — | X | X |
| 21 | 100 | 25 | 5.5 | — | — | 5.5 | 20 | 3000 | Δ | Δ |
| 22 | 100 | 25 | 5.5 | — | — | 5.5 | 100 | 100 | ◯ | ◯ |
| 23 | 100 | 25 | 5.5 | — | — | 5.5 | 250 | 100 | ⊚ | ◯ |
| 24 | 100 | — | — | 29 | 2 | — | — | — | ◯ | ◯ |
| 25 | 100 | 25 | — | 29 | 2 | 2 | — | — | X | X |
| 26 | 100 | 25 | — | 29 | 2 | 2 | 20 | 3000 | Δ | Δ |
| 27 | 100 | 25 | — | 29 | 2 | 2 | 100 | 100 | ◯ | ◯ |
| 28 | 100 | 25 | — | 29 | 2 | 2 | 250 | 100 | ⊚ | ◯ |
| 29 | 100 | — | — | — | 4 | — | — | — | ◯ | ◯ |
| 30 | 100 | 10 | — | — | 4 | 4 | — | — | X | X |
| 31 | 100 | 10 | — | — | 4 | 4 | 20 | 3000 | Δ | Δ |
| 32 | 100 | 10 | — | — | 4 | 4 | 100 | 100 | ◯ | ◯ |
| 33 | 100 | 10 | — | — | 4 | 4 | 250 | 100 | ⊚ | ◯ |

Sample Nos. 19, 24, and 29 contain a low molecular organic substance in an amount of 1,000 ppm or less, and no organic-based gas was detected from the samples.

Samples which were doped with toluene and methylethylketone and cured without being subjected to removal treatment (Sample Nos. 20, 25, and 30) contain a low molecular organic substance in an amount of 10,000 ppm or more, assume an organic-based-gas ion current of 10⁻¹¹ A or higher, and emit a large quantity of organic-based gas.

In contrast, Sample Nos. 21, 27, and 31, which have been treated under conditions of “20° C. and 3,000 Pa,” contain a low molecular organic substance in an amount and assume an organic-based gas ion current one order of magnitude smaller than those of the samples 20, 25, 30. Sample Nos. 22, 27, and 32 which have been processed at 100° C. and 100 Pa, and Sample Nos. 23, 28, and 33, which have been processed at 250° C. and 100 Pa, contain a low molecular organic substance in an amount of 1,000 ppm or less. No organic-based gas was detected from these samples.

Consequently, in order to eliminate the added organic solvent, it can be understood that the raw material must be subjected to heat/decompression treatment at a heating temperature and the vapor pressure of an organic solvent or less, thereby inhibiting emission of an organic-based gas. Further, in order to eliminate a non-reactive component, such as impurities which are mixed into a raw material and whose components are unknown, it can be understood that the raw material must be subjected to heat/decompression treatment at a heating temperature and under pressure expressed by Equation (1), thereby inhibiting emission of an organic-based gas. Any of the curing methods are understood to yield effects of heat/decompression treatment.

As a result, the amount of organic-based gas emitted is reduced by subjecting a mixture formed from epoxy resin, and a curing agent or a catalyst to heat treatment or decompression treatment, thereby enabling production of a thermosetting resin composition which involves an organic-based-gas ion current of 10⁻¹¹A or less, emits a small quantity of organic-based gas, and can be applied to a high vacuum use.

Needless to say, the treatment operations are effective for epoxy resin containing outgassing species, such as Sample Nos. 1, 7, and 13 of the first embodiment.

### THIRD EMBODIMENT

The present embodiment is an example for eliminating low molecular organic substances (such as non-reactive impurities, a non-reactive organic solvent, an unreacted raw material, and a reactive by-product) contained in a cured substance resulting from a raw material having been mixed and cured.

The low molecular organic substances (such as non-reactive impurities, a non-reactive organic solvent, an unreacted raw material, and a reactive by-product) contained in the cured substance can be considered to be removed through heat/decompression treatment.

The higher a heating temperature, the faster the diffusion of the low molecular organic substances in the cured substance and evaporation of the low molecular organic substances at the surface of the cured substance. The lower the pressure of decompression treatment, the more the low molecular organic substance becomes apt to evaporation at the surface of the cured substance. The evaporation speed is further increased by setting the pressure of decompression treatment to a level lower than vapor pressure of the low molecular organic substances. Hence, the requirements for heat/decompression treatment are the same as those in the second embodiment.

Moreover, it is considered that setting the heating temperature so as to become higher than the glass-transition temperature of the cured substance brings the cured substance in rubber form and that, as a result, the speed at which the low molecular organic substances diffuse and spread from the inside to surface of the cured substance is increased, thereby increasing the removal speed of the low molecular organic substances.

Examples of the third embodiment of the invention will now be described.

(1) Sample

Samples were formed by combination of the following materials so as to assume compounding ratios shown in Table 3.

Epoxy resin: bisphenol A type (BPA type), epoxy 190. equiv.

Diluent: Toluene

Curing agent: 4,4′diaminophenylmethane (DDM), methyltetrahydrophthalicanhydride (MeTHPA), triethylenetetraamine (TETA)

Catalyst: 2-ethyl-4-methyl-imidazole (2E4MZ).

Sample Nos. 34 to 51 were used for examining the influence of a heating temperature and the decompression treatment pressure on the spreading speed of the low molecular organic substance, and Sample Nos. 52 to 56 were used for examining the influence of spreading speed of the low molecular organic substance on the approximate glass-transition temperature of the cured resin. Sample Nos. 35, 41, 47, and 52 were added as comparative samples. These samples were made by adding 10 parts by weight of toluene, serving as a non-reactive component, to resin, and curing the resin without removal of the toluene.

(2) Method for Manufacturing Samples

Sample Nos. 36, 42, and 48 were examined for the effect of heat treatment under normal atmospheric pressure.

(3) Method for Removing Low Molecular Organic Substance

A-type of Sample Nos. 34 to 51 were subjected to removal of a low molecular organic substance from a cured substance under four requirements formed by addition of one requirement of an atmospheric pressure to the three requirements identical with those of the first embodiment. In relation to a-type of Sample Nos. 52 to 56, the pressure of decompression treatment was set to 100 Pa, and the temperature of the heat treatment was changed approximately to the glass-transition temperature of the cured substance. The treatment time was set to 50 hours.

The-type of Sample Nos. 34 to 51 were treated under the following conditions.

20° C.×3000 Pa: Sample Nos. 37, 43, 49

100° C.×100 Pa: Sample Nos. 38, 44, 50 [the pressure 100 Pa at 100° C. is lower than the vapor pressure of toluene at 100° C. but higher than the pressure at 100° C. determined by Equation (1)]

250° C.×100 Pa: Sample Nos. 39, 45, 51 [the pressure 100 Pa at 250° C. is lower than the pressure at 250° C. determined by Equation (1)]

150° C.×101300 Pa (normal atmospheric pressure): Sample Nos. 36, 42, 48

When the temperature of decompression treatment has become too high, there arises apprehension that the cured substance becomes thermally decomposed, whereby a decomposition product becomes an outgassing species. Hence, the maximum temperature was set to 250° C.

In relation to Sample Nos. 53 through 56, the treatment pressure was made constant at 100 Pa, and the heating temperature was changed to 60° C. to 120° C. in the vicinity of the glass-transition temperature of the cured substance.

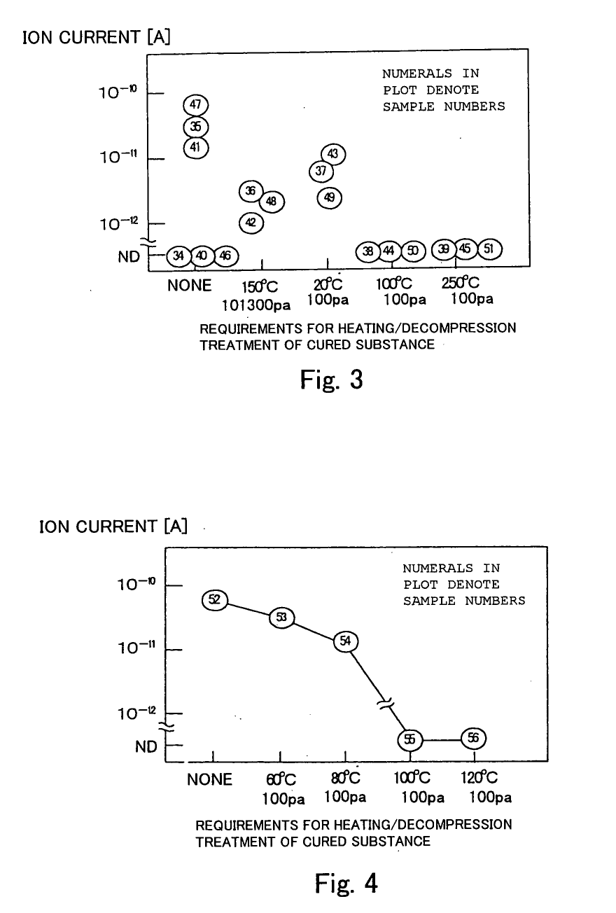

Next, the content of low molecular organic substance and the quantity of organic-based gas emitted were measured. Results of measurement are provided in Table 3 and FIG. 3.

TABLE 3

| | | | | | | | | | EVALUATION | |
|---|---|---|---|---|---|---|---|---|---|---|
| | MATERIAL COMPOUNDING RATIO | | | | | | REQUIREMENTS | | PERCENTAGE | |
| | EPOXY | | | | | | FOR REMOVAL | | OF LOW- | AMOUNT OF |
| | BPA TYPE | | CURING | | | | OPERATION | | MOLECULAR | ORGANIC- |
| SAMPLE | (190 | DILUENT | AGENT | | | CATALYST | TEMP | PRESSURE | ORGANIC | BASED GAS |
| NO. | EQUIV.) | TOLUENE | DDM | MeTHPA | TETA | 2E4MZ | (° C.) | (Pa) | SUBSTANCE | EMISSION |
| 34 | 100 | — | 28 | — | — | — | — | — | ◯ | ◯ |
| 35 | 100 | 10 | 28 | — | — | — | — | — | X | X |
| 36 | 100 | 10 | 28 | — | — | — | 150 | 101300 | Δ | Δ |
| 37 | 100 | 10 | 28 | — | — | — | 20 | 3000 | Δ | Δ |
| 38 | 100 | 10 | 28 | — | — | — | 100 | 100 | ◯ | ◯ |
| 39 | 100 | 10 | 28 | — | — | — | 250 | 100 | ⊚ | ◯ |
| 40 | 100 | — | — | 80 | — | — | — | — | ◯ | ◯ |
| 41 | 100 | 10 | — | 80 | — | 2 | — | — | X | X |
| 42 | 100 | 10 | — | 80 | — | 2 | 150 | 101300 | Δ | Δ |
| 43 | 100 | 10 | — | 80 | — | 2 | 20 | 3000 | Δ | Δ |
| 44 | 100 | 10 | — | 80 | — | 2 | 100 | 100 | ◯ | ◯ |
| 45 | 100 | 10 | — | 80 | — | 2 | 250 | 100 | ⊚ | ◯ |
| 46 | 100 | — | — | — | — | 4 | — | — | ◯ | ◯ |
| 47 | 100 | 10 | — | — | — | 4 | — | — | X | X |
| 48 | 100 | 10 | — | — | — | 4 | 150 | 101300 | Δ | Δ |
| 49 | 100 | 10 | — | — | — | 4 | 20 | 3000 | Δ | Δ |
| 50 | 100 | 10 | — | — | — | 4 | 100 | 100 | ◯ | ◯ |
| 51 | 100 | 10 | — | — | — | 4 | 250 | 100 | ⊚ | ◯ |
| 52 | 100 | 10 | — | — | 5 | — | — | — | X | X |
| 53 | 100 | 10 | — | — | 5 | — | 60 | 100 | X | X |
| 54 | 100 | 10 | 10 | — | 5 | — | 80 | 100 | Δ | X |
| 55 | 100 | 10 | 10 | — | 5 | — | 100 | 100 | ◯ | ◯ |
| 56 | 100 | 10 | 10 | — | 5 | — | 120 | 100 | ◯ | ◯ |

As can be seen from FIG. 3, Sample Nos. 34, 40, and 46 contain a low molecular organic substance in an amount of 1,000 ppm or less, and no organic-based gas was detected from the samples. Sample Nos. 35, 41, and 47, which were not been subjected to removal of toluene, contain a low molecular organic substance in an amount of 10,000 ppm or more, assume an organic-based-gas ion current of 10⁻¹¹ A or higher, and emit a large quantity of organic-based gas. In contrast, Sample Nos. 36, 42, and 48, which had been subjected to treatment under normal atmospheric pressure (101, 300 Pa) at 150° C. and Sample Nos. 37, 43, and 49, which had been treated under conditions of “20° C. and 3,000 Pa, ” contain a low molecular organic substance in an amount and assume an organic-based gas ion current one order of magnitude smaller than those of the samples 34, 40, 46.

Sample Nos. 38, 44, and 50, which have been processed at 100° C. and 100 Pa, and Sample Nos. 39, 45, and 51, which have been processed at 250° C. and 100 Pa, contain a low molecular organic substance in an amount one order of magnitude smaller than those of the samples 34, 40, and 46. No organic-based gas was detected from these samples.

Consequently, emission of an organic-based gas can be inhibited by removal of the non-reactive component, the unreacted material, and a reactive by-product. In order to eliminate the added organic solvent, it can be understood that the raw material must be subjected to heat/decompression treatment at a heating temperature and the pressure expressed by Equation (1) or less, thereby inhibiting emission of an organic-based gas. Further, in order to eliminate a non-reactive component, such as impurities which are mixed into a raw material and whose components are unknown, a non-reactive material, or a by-product stemming from curing reaction, it can be understood that the raw material must be subjected to heat/decompression treatment at a heating temperature and the pressure expressed by Equation (1), thereby inhibiting emission of an organic-based gas. Any of the curing methods are understood to yield effects of heat/decompression treatment.

FIG. 4 shows that a small difference exists between the quantity of organic-based gas emitted from Sample Nos. 53 and 54, which have been subjected to heat/decompression treatment at a temperature equal to or less than the glass-transition temperature (90° C.) of the cured substance, and the quantity of organic-based gas emitted from Sample No. 52, which has not been subjected to heat/decompression treatment. However, there was observed a decrease of one order of magnitude between the quantity of organic-based gas emitted from Sample Nos. 55 and 56, which have been subjected to heat/decompression treatment at a temperature equal to or higher than the glass-transition temperature, and the quantity of organic-based gas emitted from Sample No. 52, which has not been subjected to heat/decompression treatment. When the temperature at which the cured substance is to be subjected to heat treatment is equal to or higher than the glass-transition temperature of the cured substance, the removal effect of the low molecular organic substance is great. An effect of inhibition of organic-based gas becomes high, and the effect is found to become smaller at temperatures lower than or equal to the glass-transition temperature.

Therefore, the amount of organic-based gas emitted is reduced by subjecting the cured epoxy resin substance to heat treatment or decompression treatment, thereby enabling production of a thermosetting resin composition which involves an organic-based-gas ion current of 10⁻¹¹ A or less, emits a small quantity of organic-based gas, and can be applied to a high vacuum use.

Needless to say, the treatment operations are effective for epoxy resin containing outgassing species, such as Sample Nos. 1, 7, and 13.

### FOURTH EMBODIMENT

The present embodiment is an example for preventing emission of an organic-based gas by causing reaction through use of a polyaddition-type curing agent, to thereby prevent remaining of unreacted epoxy resin and a curing agent in a cured substance.

In the case of the epoxy resin composition using the polyaddition-type curing agent, unreacted epoxy resin and the curing agent remain in the cured substance, thereby becoming outgassing species. In order to prevent generation of the outgassing species, during curing treatment the epoxy resin and the curing agent must be reacted to at least oligomer; that is, a molecular weight such that the epoxy resin and the curing agent do not become gasified.

A theoretical stoichiometric ratio of epoxy resin to a curing agent achieved when the epoxy resin and the curing agent are subjected to curing reaction without involvement of an excess or deficiency is one. Namely, epoxy radicals in epoxy resin are equal in number to functional-types which are contained in the curing agent and cause curing reaction. In reality, self-crosslinking reaction of epoxy resin arises, depending on a combination of epoxy resin with a curing agent. Hence, a stoichiometric ratio achieved when curing reaction arises without an excess or deficiency is not necessarily one. Specifically, there is a range of stoichiometric ratio in which an organic-based gas is not emitted, and the range was found through experiments.

Examples of the fourth embodiment of the invention will now be described.

The present embodiment is an example for eliminating a low molecular organic substance contained in a cured substance after curing (e.g., non-reactive impurities, a non-reactive organic solvent, an unreacted material, and an unreacted by-product).

Samples were manufactured in the following manner. Here, the method for evaluating cured substances and display of evaluation results are the same as those employed in the first embodiment.

(1) Sample

Samples were formed by combination of the following materials so as to assume compounding ratios shown in Table 4.

Epoxy resin: bisphenol A type (BPA type), epoxy 190. equiv.

Diluent: Toluene

Polyaddition-type Curing agent: 4-4′diaminophenylsulphone (DDS), methyltetrahydrophthalic anhydride (MeTHPA), a phenolic-novolak-type curing agent, and polymercaptan-type curing agent

Catalyst: 2-ethyl-4-methyl-imidazole (2E4MZ).

(2) Method for Manufacturing Samples

Samples were prepared by blending and curing epoxy resin, a curing agent, and a catalyst. Curing of resin was conducted in three manners as in the case of the first embodiment; that is, a method for adding solely a curing agent to epoxy resin; a method for adding a curing agent to epoxy resin along with a catalyst; and a method for adding solely a catalyst to epoxy resin. All the samples were cured at 150° C. for five hours.

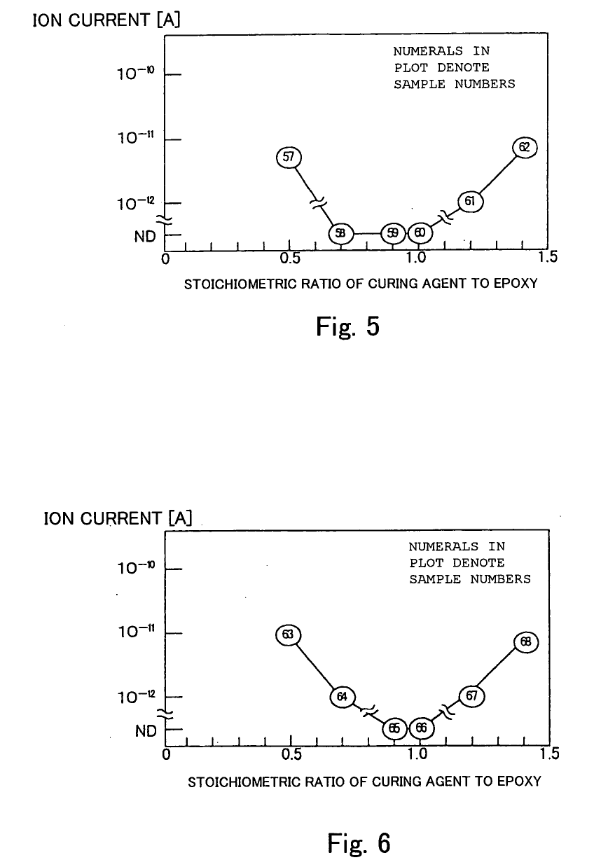

Next, the content of low molecular organic substance and the quantity of organic-based gas emitted were measured. Results of measurement are provided in Table 4 and FIGS. 5 through 9.

TABLE 4

| | MATERIAL COMPOUNDING RATIO | | | | | | | EVALUATION | |
|---|---|---|---|---|---|---|---|---|---|
| | EPOXY | CURING | | | | | EQUIVALENT | PERCENTAGE | AMOUNT OF |
| | BPA TYPE | AGENT | | | | | RATIO OF | OF LOW- | ORGANIC- |
| SAMPLE | (190 | | | PHENOL | AROMATIC | CATALYST | CURING AGENT | MOLECULAR | BASED GAS |
| NO. | EQUIV.) | DDS | MeTHPA | NOVOLAK | THIOETHER | 2E4MZ | (TO EPOXY) | SUBSTANCE | EMISSION |
| 57 | 100 | 17 | — | — | — | — | 0.5 | Δ | Δ |
| 58 | 100 | 23 | — | — | — | — | 0.7 | ◯ | ◯ |
| 59 | 100 | 30 | — | — | — | — | 0.9 | ⊚ | ◯ |
| 60 | 100 | 33 | — | — | — | — | 1 | ◯ | ◯ |
| 61 | 100 | 40 | — | — | — | — | 1.2 | ◯ | ◯ |
| 62 | 100 | 50 | — | — | — | — | 1.5 | Δ | Δ |
| 63 | 100 | — | 44 | — | — | 1 | 0.5 | Δ | Δ |
| 64 | 100 | — | 61 | — | — | 1 | 0.7 | ◯ | ◯ |
| 65 | 100 | — | 82 | — | — | 1 | 0.9 | ⊚ | ◯ |
| 66 | 100 | — | 87 | — | — | 1 | 1 | ◯ | ◯ |
| 67 | 100 | — | 105 | — | — | 1 | 1.2 | Δ | ◯ |
| 68 | 100 | — | 131 | — | — | 1 | 1.5 | Δ | Δ |
| 69 | 100 | — | — | 17 | — | — | 0.3 | X | X |
| 70 | 100 | — | — | 29 | — | — | 0.5 | Δ | Δ |
| 71 | 100 | — | — | 46 | — | — | 0.7 | ⊚ | ◯ |
| 72 | 100 | — | — | 57 | — | — | 1 | ◯ | ◯ |
| 73 | 100 | — | — | 63 | — | — | 1.2 | Δ | Δ |
| 74 | 100 | — | — | 74 | — | — | 1.5 | X | X |
| 75 | 100 | — | — | 17 | — | 1 | 0.3 | X | X |
| 76 | 100 | — | — | 29 | — | 1 | 0.5 | Δ | Δ |
| 77 | 100 | — | — | 46 | — | 1 | 0.8 | ⊚ | ◯ |
| 78 | 100 | — | — | 57 | — | 1 | 1.1 | ◯ | ◯ |
| 79 | 100 | — | — | 63 | — | 1 | 1.2 | Δ | Δ |
| 80 | 100 | — | — | 74 | — | 1 | 1.5 | X | X |
| 81 | 100 | — | — | — | 35 | — | 0.3 | X | X |
| 82 | 100 | — | — | — | 58 | — | 0.5 | Δ | Δ |
| 83 | 100 | — | — | — | 70 | — | 0.6 | ⊚ | ◯ |
| 84 | 100 | — | — | — | 104 | — | 0.9 | ⊚ | ◯ |
| 85 | 100 | — | — | — | 116 | — | 1 | Δ | Δ |
| 86 | 100 | — | — | — | 140 | — | 1.2 | Δ | X |
| 87 | 100 | — | — | — | 35 | 1 | 0.3 | X | X |
| 88 | 100 | — | — | — | 58 | 1 | 0.5 | Δ | Δ |
| 89 | 100 | — | — | — | 70 | 1 | 0.6 | ⊚ | ◯ |
| 90 | 100 | — | — | — | 104 | 1 | 0.9 | ◯ | ◯ |
| 91 | 100 | — | — | — | 116 | 1 | 1 | Δ | Δ |
| 92 | 100 | — | — | — | 140 | 1 | 1.2 | X | X |

As can be seen from FIG. 5, Sample Nos. 57 to 62 doped with an amine-type curing agent contain a low molecular organic substance in an amount of 10,000 ppm or less within the range of stoichiometric ratio from 0.5 to 1.4. The samples also assume an organic-based-gas ion current of 10⁻¹¹ A or less and emit a small quantity of organic-based gas.

Within the range of stoichiometric ratio from 0.7 to 1.2, the samples contain low molecular organic substance in an amount of 1,000 ppm or less. An organic-based-gas ion current of 10⁻¹² A or less was detected. Thus, no substantial organic-based gas ion current was detected.

As shown in FIG. 6, acid-anhydride-type curing agents (Sample Nos. 63 through 68) doped with a catalyst contain a low molecular organic stance in an amount of 10,000 ppm or less within the range of stoichiometric ratio from 0.5 to 1.4. The samples also assume an organic-based-gas ion current of 10⁻¹¹ A or less and emit a small quantity of organic-based gas. Within the range of stoichiometric ratio from 0.7 to 1.2, the samples contain low molecular organic substance in an amount of 1,000 ppm or less. An organic-based-gas ion current of 10⁻¹² A or less was detected. Thus, no substantial organic-based gas ion current was detected.

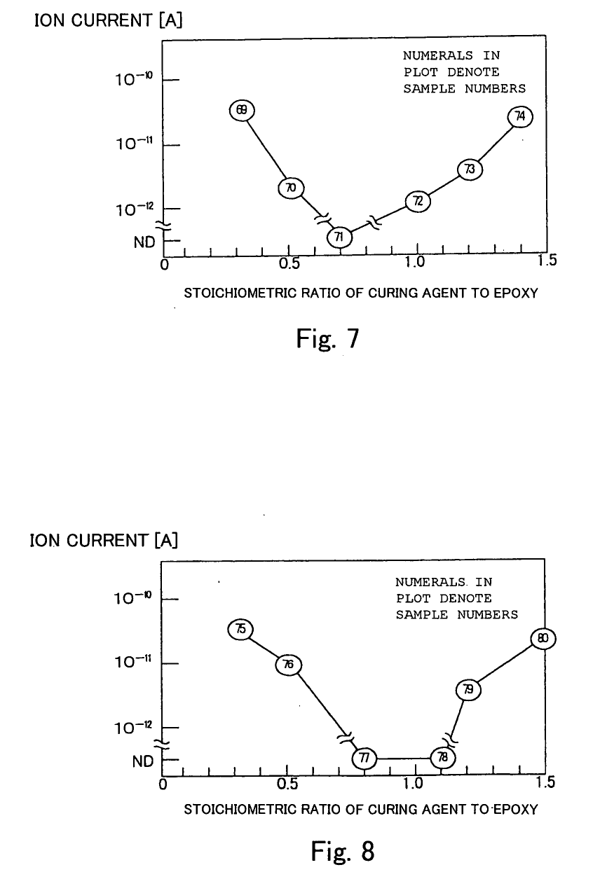

As shown in FIG. 7, Sample Nos. 69 to 74 doped with a phenolic-novolak-type curing agent contain a low molecular organic stance in an amount of 10,000 ppm or less within the range of stoichiometric ratio from 0.5 to 1.2. The samples also assume an organic-based-gas ion current of 10⁻¹¹ A or less and emit a small quantity of organic-based gas. Within the range of stoichiometric ratio from 0.7 to 1.0, the samples contain low molecular organic substance in an amount of 1,000 ppm or less. An organic-based-gas ion current of 10⁻¹² A or less was detected. Thus, no substantial organic-based gas ion current was detected.

Sample Nos. 75 to 80 doped with a catalyst and a phenolic-novolak-type curing agent are as shown in FIG. 8. The samples contain a low molecular organic stance in an amount of 10,000 ppm or less within the range of stoichiometric ratio from 0.5 to 1.2. The samples also assume an organic-based-gas ion current of 10⁻¹¹ A or less and emit a small quantity of organic-based gas. Within the range of stoichiometric ratio from 0.8 to 1.1, the samples contain low molecular organic substance in an amount of 1,000 ppm or less. An organic-based-gas ion current of 10⁻¹² A or less was detected. Thus, no substantial organic-based gas ion current was detected.

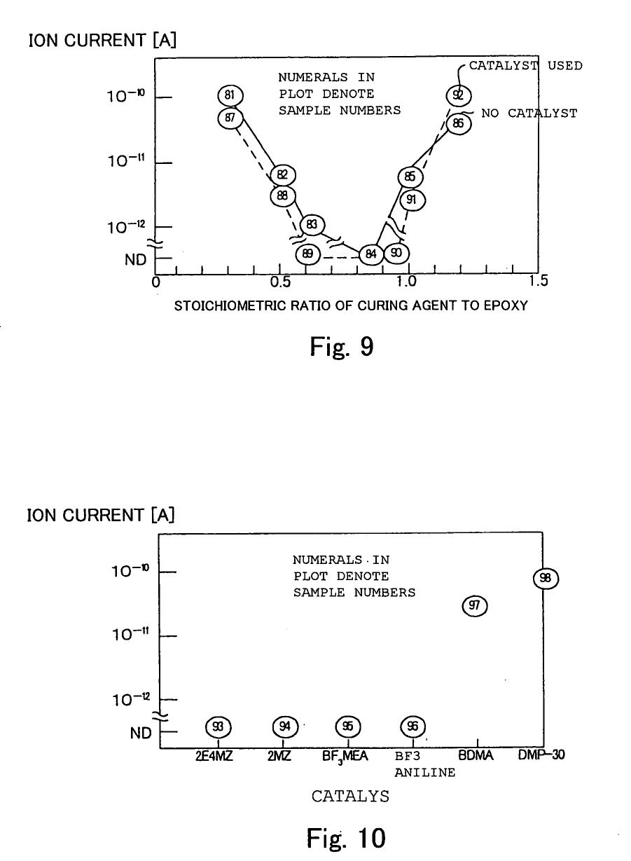

Sample Nos. 81 to 86 doped with a polymercaptan-type curing agent and Sample Nos. 87 to 92 doped with a polymercaptan-type curing agent along with a catalyst are as shown in FIG. 9. The samples contain a low molecular organic stance in an amount of 10,000 ppm or less within the range of stoichiometric ratio from 0.5 to 1.0. The samples also assume an organic-based-gas ion current of 10⁻¹¹ A or less and emit a small quantity of organic-based gas. Within the range of stoichiometric ratio from 0.6 to 0.9, the samples contain low molecular organic substance in an amount of 1,000 ppm or less. An organic-based-gas ion current of 10⁻¹² A or less was detected. Thus, no substantial organic-based gas ion current was detected.

Consequently, even in this embodiment, a thermosetting resin composition which is smaller in the quantity of emitted organic-based gas than a conventional thermosetting resin composition can be produced by adjusting a stoichiometric ratio of epoxy radical to a curing agent with regard to a curing reaction through use of a polyaddition-type curing agent.

### FIFTH EMBODIMENT

The present embodiment is an example for preventing remaining of unreacted epoxy resin and a curing agent by subjecting epoxy resin to crosslinking through addition of a catalyst.

In relation to an epoxy resin composition using a polyaddition-type curing agent, an unreacted material remains in a cured substance and becomes an outgassing species, depending on a compounding ratio of a main compound to a curing agent or curing conditions. Further, in the case of a reaction mechanism through which a by-product is produced by curing reaction, the resultant by-product becomes an outgassing species.

Therefore, remaining of unreacted epoxy resin and the curing agent can be prevented regardless of the stoichiometric ratio of epoxy resin to the curing agent by subjecting epoxy resin to self-crosslinking through use of a catalyst.

Examples of the fifth embodiment of the invention will now be described.

Samples were manufactured in the following manner. Here, the method for evaluating cured substances and display of evaluation results are the same as those in the first embodiment.

(1) Sample

Samples were formed by combination of the following materials so as to assume compounding ratios shown in Table 5.

Epoxy resin: bisphenol F type (BPF type), epoxy 172. equiv.

Diluent: Methyl-nasic-acid-anhidride (MNA)

Catalyst: 2-ethyl-4-methyl-imidazole (2E4MZ), 2-methylimidazole (2MZ), a borontrifluoride-monoethylamine complex (BF3·MEA), a borontrifluoride-aniline complex (BF3·aniline), benzildimethylamine (BDMA), 2,4,6-tris(diaminomethyl)phenol(DMP-30)

(2) Method for Manufacturing Samples

Sample Nos. 93 and 94 are examples using an imidazole compound catalyst; Sample No. 93 is an example using 2-ethyl-4-methyl-imidazole; and Sample No. 94 is an example using 2-methylimidazole. Sample Nos. 95 and 96 are examples using a cationic-polymerization-type catalyst. Sample No. 95 is an example using a borontrifluoride-monoethylamine complex. Sample No. 96 is an example using a borontrifluoride-aniline complex. As examples in which a by-product is produced through curing reaction, methyl-nasic-acid-anhidride was blended with Sample No. 97 while benzildimethylamine was taken as a catalyst, and methyl-nasic-acid-anhidride was blended with Sample No. 98 while 2,4,6-tris(diaminomethyl)phenol(DMP-30) was taken as a catalyst. All samples were cured under the following curing conditions: 150° C. and five hours.

Next, the content of low molecular organic substance and the quantity of organic-based gas emitted were measured. Results of measurement are provided in Table 5 and FIG. 10.

TABLE 5

| | MATERIAL COMPOUNDING RATIO | | | | | | | | EVALUATION | | |
|---|---|---|---|---|---|---|---|---|---|---|---|
| | EPOXY | | | | | | | | CONTENT | QUANTITY | |
| | BPA | | | | | | | | OF LOW | OF EMITTED | PRESENCE/ |
| | TYPE | CURING | CATALYST | | | | | | MOLECULAR | ORGANIC- | ABSENCE |
| SAMPLE | (172 | AGENT | | | BF3 [symbol] | BFS [symbol] | | | ORGANIC | BASED | OF BY- |
| No. | EQUIV.) | MNA | 2E4MZ | 2MZ | MEA | ANILINE | BDMA | DMP-30 | SUBSTANCE | GAS | PRODUCTS |
| 93 | 100 | — | 4 | — | — | — | — | — | ◯ | ◯ | ABSENT |
| 94 | 100 | — | — | 4 | — | — | — | — | ◯ | ◯ | ABSENT |
| 95 | 100 | — | — | — | 4 | — | — | — | ◯ | ◯ | ABSENT |
| 96 | 100 | — | — | — | — | 4 | — | — | ◯ | ◯ | ABSENT |
| 97 | 100 | 95 | — | — | — | — | 1 | — | Δ | X | PRESENT |
| 98 | 100 | 95 | — | — | — | — | — | 1 | Δ | X | PRESENT |

Sample Nos. 93, 94 using the imidazole compound catalyst and Sample Nos. 95, 96 using the cationic-polymerization-type catalyst contain a low molecular organic substance in an amount of 1,000 ppm or less, and no organic-based gas was detected. In contrast, Sample Nos. 97, 98 using a catalyst which causes by-products contain a low molecular organic substance in an amount of 10,000 ppm or less. Although the samples assume an organic-based-gas ion current of 10⁻¹¹ A or less, the organic-based gas was detected. Consequently, even in this embodiment, a thermosetting resin composition which is smaller in the quantity of emitted organic-based gas than a conventional thermosetting resin composition can be produced by subjecting epoxy resin to self-polymerization by means of an imidazole compound catalyst or a cationic-polymerization-type catalyst.

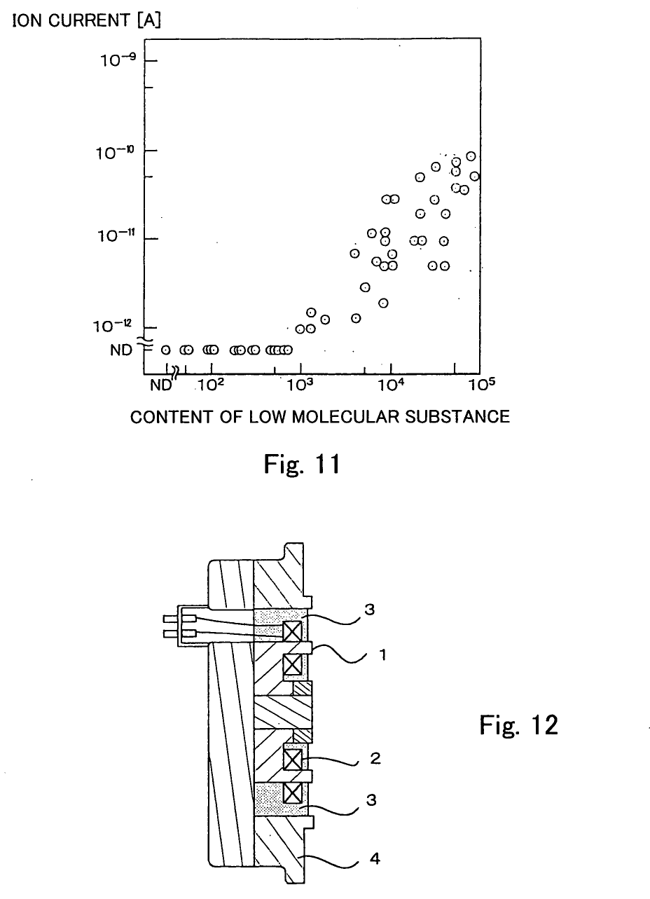

FIG. 11 shows a summary of cataloged data pertaining to the content of low molecular organic substance and the quantity of emitted gas, which have been thus far described in connection with the first through fifth embodiments. FIG. 11 is a view showing a relationship between the content of a low molecular organic substance and the quantity of emitted gas.

As can be seen from the view, the quantity of emitted organic-based gas becomes smaller as the content of low molecular organic substance decreases. When the content of low molecular organic substance is 10,000 ppm or less, the quantity of emitted organic-based gas becomes very small. When the content of low molecular organic substance is 1,000 ppm or less, emission of an organic-based gas is found not to be detected. As a result, use of the method described in connection with the first through fifth embodiments enable production of a superior vacuum-use device which emits a gas in small quantity.

### SIXTH EMBODIMENT

The present embodiment is an example application of the invention to a vacuum-use device.

An organic-based gas emitted, in a vacuum, from a vacuum-use device employing a conventional thermosetting resin composition is dominantly emitted from the thermosetting resin composition. Here, when the conventional thermosetting resin composition is replaced with any of the thermosetting resin compositions which have been found in the first through fifth embodiments and emit an organic-based gas in a small quantity, the quantity of organic-based gas emitted from the vacuum device becomes smaller in proportion to the quantity of organic-based gas emitted from a thermosetting resin composition unit.

Examples of the sixth embodiment will now be described.

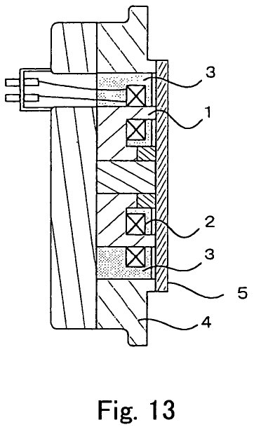

An electromagnetic coil having a structure shown in FIG. 12 was used as a vacuum-use device. The quantity of emitted organic-based gas was measured in the same manner as in the first embodiment while the requirements for blending, heating, and decompressing a thermosetting resin composition used for a mold 3 were changed. In FIG. 12, reference numeral 1 designates a stator core; 2 designates a coil; 3 designates a mold formed from a thermosetting resin composition; and 4 designates a stator housing. In terms of these elements, the electromagnetic coil of the embodiment is identical with the related-art electromagnetic coil shown in FIG. 13. However, a can 5 is not attached to the electromagnetic coil of this embodiment.

The following six types of molds were used for the mold 3. Specifically, Sample No. 6 prepared by removing a non-reactive composition from a raw material; Sample No. 28 prepared by removing a non-reactive composition from the raw material while the raw material was being mixed; Sample Nos. 48 and 51 prepared by removing a low molecular organic substance from a cured substance; Sample No. 59 prepared by blending a polyaddition-type curing agent to a raw material in an optimal compounding ratio; and Sample No. 93 prepared by use of a catalyst. Sample No. 1 containing a large quantity of impurities and Sample No. 3 containing a large quantity of low molecular organic substance were selected as comparative examples. All the molds 3 were manufactured under the same requirements as those of the samples.

As a result of measurement of the quantity of organic-based gas emitted from the electromagnetic coil, there was detected emission of no organic-based gas from the electromagnetic coils using six types of samples Nos. 6, 28, 48, 51, 59, and 93 as the molds 3.

In contrast, there was detected emission of a large quantity of organic-based gas from the electromagnetic coils using Sample No. 1 containing a large quantity of impurities and Sample No. 3 containing a large quantity of low molecular organic substance, both being used as comparative examples.

As mentioned above, since no organic-based gas is emitted from the vacuum-use device using the thermosetting resin composition for vacuum of the invention, a problem attributable to an organic-based gas in a high vacuum has been solved.

The vacuum-use device of the invention is not limited to an electromagnetic coil having a coil molded therein. The vacuum-use device can be applied to, for example, a structural member of a robot arm for use in a vacuum; a member using metal material for preventing problems stemming from emission of an organic-based gas, such as a vacuum chamber, and a housing of a vacuum-use device; a substrate of electric equipment for use in a vacuum which is molded in resin or coated with resin; an insulating material/adhesive for constituting an electrical appliance for use in a vacuum; and a device for vacuum use separated from a high vacuum atmosphere for solving problems attributable to emission of an organic-based gas. Application of the thermosetting resin composition of the invention to the vacuum-use device is effective for solving problems whose basic causes are emission of an organic-based gas.

The invention is not limited to an epoxy resin composition and is effective for thermosetting resin compositions, such as an unsaturated polyester resin composition, a silicon resin composition, a polyurethane resin composition, a vinyl ester resin composition, and an alkyd resin composition.

### INDUSTRIAL APPLICABILITY

A vacuum-use device of the invention is utilized for, for example, an electromagnetic coil having a coil molded therein; a structural member of a robot arm for use in a vacuum; a member using metal material for preventing problems stemming from emission of an organic-based gas, such as a vacuum chamber, and a housing of a vacuum-use device; a substrate of electric equipment for use in a vacuum which is molded in resin or coated with resin; and an insulating material/adhesive for constituting an electrical appliance for use in a vacuum.

1. A thermosetting resin composition for use in a vacuum, comprising:
a main compound and at least either a curing agent or a catalyst, which are blended together, wherein a low-molecular organic substance having a molecular weight of 400 or less in the composition has a content of 10,000 ppm or less, preferably 1,000 ppm or less.

2. The thermosetting resin composition for use in a vacuum according to claim 1, wherein the main compound is epoxy resin.

3. The thermosetting resin composition for use in a vacuum according to claim 2, wherein the molecular organic substance is removed through heat treatment or decompression treatment.

4. The thermosetting resin composition for use in a vacuum according to claim 2 or 3, wherein the curing agent is of polyaddition type.

5. The thermosetting resin composition for use in a vacuum according to claim 4, wherein the curing agent is primary amine or secondary amine, and a stoichiometric ratio of active hydrogen of the curing agent to an epoxy radical of the epoxy resin is 0.5 to 1.4, preferably 0.7 to 1.2.

6. The thermosetting resin composition for use in a vacuum according to claim 4, wherein the curing agent is acid anhydride, and a stoichiometric ratio of an acid anhydride radical to an epoxy radical of the epoxy resin is 0.5 to 1.4, preferably 0.7 to 1.2.

7. The thermosetting resin composition for use in a vacuum according to claim 4, wherein the curing agent is phenolic novolak, and a stoichiometric ratio of a phenolic hydroxyl-type to an epoxy radical of the epoxy resin is 0.5 to 1.2, preferably 0.5 to 1.0.

8. The thermosetting resin composition for use in a vacuum according to claim 4, wherein the curing agent is phenolic novolak; a stoichiometric ratio of a phenolic hydroxyl-type to an epoxy radical of the epoxy resin is 0.5 to 1.2, preferably 0.6 to 1.1; and the catalyst is a basic catalyst.

9. The thermosetting resin composition for use in a vacuum according to claim 4, wherein the curing agent is polymercaptan, and a stoichiometric ratio of active hydrogen of the curing agent to an epoxy radical of the epoxy resin is 0.5 to 1.0, preferably 0.6 to 0.9.

10. The thermosetting resin composition for use in a vacuum according to any one of claims 2 to 9, wherein the catalyst is imidazole or of cationic polymerization type.

11. A device for use in a vacuum comprising the thermosetting resin composition for use in a vacuum defined in any one of claims 1 through 10.

12. A method for manufacturing a thermosetting resin composition for use in a vacuum by blending epoxy resin with at least a curing agent or a catalyst and curing the same, wherein the composition is subjected to heat treatment or decompression treatment, and a low molecular organic substance having a molecular weight of 400 or less is set to a content of 10,000 ppm or less, preferably 1,000 ppm or less, with reference to the overall weight of the composition.

13. The method for manufacturing a thermosetting resin composition for use in a vacuum according to claim 12, wherein a state of the composition achieved when the composition is subjected to the heat treatment or the decompression treatment is set to either a component unit or mixture before curing or a cured substance after curing.

14. The method for manufacturing a thermosetting resin composition for use in a vacuum according to claim 13, wherein the temperature employed for heat treatment is set to 250° C. or less; a pressure P employed in the decompression treatment is set to a vapor pressure of the low molecular organic substance or less at the temperature T, preferably, a pressure defined by the following equation:
log₁₀ P<8.125−2000/(T−73.15)
P: a pressure employed in decompression treatment [Pa], T: a temperature employed in heat treatment [K].

15. The method for manufacturing a thermosetting resin composition for use in a vacuum according to claim 14, wherein the temperature T is higher than or equal to a glass-transition temperature of the cured substance.

16. A method for manufacturing a thermosetting resin composition for use in a vacuum by blending epoxy resin with at least a curing agent or a catalyst and curing the same, wherein the curing agent is of polyaddition type, and a low molecular organic substance having a molecular weight of 400 or less is set to a content of 10,000 ppm or less, preferably 1,000 ppm or less, with reference to the overall weight of the composition.

17. The method for manufacturing a thermosetting resin composition for use in a vacuum according to claim 16, wherein the curing agent is primary amine or secondary amine, and a stoichiometric ratio of active hydrogen of the curing agent to an epoxy radical of the epoxy resin is 0.5 to 1.4, preferably 0.7 to 1.2.

18. The method for manufacturing a thermosetting resin composition for use in a vacuum according to claim 16, wherein the curing agent is acid anhydride, and a stoichiometric ratio of an acid anhydride radical to an epoxy radical of the epoxy resin is 0.5 to 1.4, preferably 0.7 to 1.2.

19. The method for manufacturing a thermosetting resin composition for use in a vacuum according to claim 16, wherein the curing agent is phenolic novolak, and a stoichiometric ratio of a phenolic hydroxyl-type to an epoxy radical of the epoxy resin is 0.5 to 1.2, preferably 0.5 to 1.0.

20. The method for manufacturing a thermosetting resin composition for use in a vacuum according to claim 16, wherein the curing agent is phenolic novolak; a stoichiometric ratio of a phenolic hydroxyl-type to an epoxy radical of the epoxy resin is 0.5 to 1.2, preferably 0.6 to 1.1; and the catalyst is a basic catalyst.

21. The method for manufacturing a thermosetting resin composition for use in a vacuum according to claim 16, wherein the curing agent is polymercaptan, and a stoichiometric ratio of active hydrogen of the curing agent to an epoxy radical of the epoxy resin is 0.5 to 1.0, preferably 0.6 to 0.9.

22. The method for manufacturing a thermosetting resin composition for use in a vacuum according to any one of claims 12 through 21, wherein the catalyst is imidazole or of cationic polymerization type.
